(19) United States
(12) Patent Application Publication
(10) Pub. No.: US 2024/0237844 A1
(43) Pub. Date: Jul. 18, 2024

(54) Hot Beverage Brewing Device

(71) Applicant: Fred Ramberg, Miami Beach, FL (US)

(72) Inventor: Fred Ramberg, Miami Beach, FL (US)

(21) Appl. No.: 18/097,437

(22) Filed: Jan. 16, 2023

(51) Int. Cl. A47J 31/06; A47J 31/44

(52) U.S. Cl. CPC A47J 31/0636; A47J 31/0626; A47J 31/4407

(57) ABSTRACT

A beverage cup lid device is described herein that may include a beverage flavoring pod adhered to the beverage cup lid. The device may include the beverage flavoring pod comprising: a first beverage filter, beverage flavoring material on the first beverage filter, and a second beverage filter covering the beverage flavoring material and adhered to the first beverage filter.

### CROSS REFERENCE

This patent application is a priority patent application.

### FIELD OF THE INVENTION

The present inventions relate generally to the field of beverages. More specifically, the present inventions discuss a device for brewing hot beverages.

### BACKGROUND OF THE INVENTIONS

While coffee, hot chocolate, and other beverages have been served for centuries, the methods of conveniently brewing these beverages still require improvement to lower costs, eliminate waste, increase the speed of preparation, and generally provide a more convenient way to allow users to prepare their beverage.

### SUMMARY OF THE INVENTIONS

In some aspects, the techniques described herein relate to an apparatus including: a beverage cup lid; a beverage flavoring pod adhered to the beverage cup lid; and the beverage flavoring pod including: a first beverage filter; beverage flavoring material on the first beverage filter; and a second beverage filter covering the beverage flavoring material and adhered to the first beverage filter.

In some aspects, the techniques described herein relate to an apparatus wherein the beverage flavoring material is coffee.

In some aspects, the techniques described herein relate to an apparatus wherein the beverage flavoring material is tea.

In some aspects, the techniques described herein relate to an apparatus wherein the beverage flavoring pod is heat adhered to the beverage cup lid.

In some aspects, the techniques described herein relate to an apparatus the beverage flavoring pod adheres to the beverage cup lid with a hot crimped clip.

In some aspects, the techniques described herein relate to an apparatus the beverage flavoring pod is heat adhered to the beverage cup lid with an adhesive.

In some aspects, the techniques described herein relate to an apparatus wherein the beverage flavoring pod is mounted below the beverage cup lid.

In some aspects, the techniques described herein relate to an apparatus wherein the first beverage filter and the second beverage filter adhere to the beverage cup lid with a single adhesion mechanism.

In some aspects, the techniques described herein relate to an apparatus wherein the beverage cup lid has a sealing surface.

In some aspects, the techniques described herein relate to an apparatus wherein the beverage cup lid has a brewing hole.

In some aspects, the techniques described herein relate to a method for brewing a beverage including: heating a liquid; forcing the liquid through a beverage cup lid, where a beverage flavoring pod is attached to the beverage cup lid; encasing the beverage flavoring pod with the liquid; and the liquid flowing through the beverage flavoring pod into a beverage cup, the beverage cup mounted below the beverage cup lid.

In some aspects, the techniques described herein relate to a method wherein the liquid is forced through the beverage cup lid through gravity.

In some aspects, the techniques described herein relate to a method wherein the liquid is heated to steam.

In some aspects, the techniques described herein relate to a method wherein the beverage flavoring pod includes: a first beverage filter; beverage flavoring material on the first beverage filter; and a second beverage filter covering the beverage flavoring material and adhered to the first beverage filter.

In some aspects, the techniques described herein relate to a method wherein the beverage flavoring material is coffee.

In some aspects, the techniques described herein relate to a method wherein the beverage flavoring material is tea.

In some aspects, the techniques described herein relate to a method wherein the liquid is water.

In some aspects, the techniques described herein relate to a method wherein the liquid is heated to a super-heated state before it is forced into the beverage cup lid.

In some aspects, the techniques described herein relate to a method wherein the beverage flavoring pod is attached below the beverage cup lid.

In some aspects, the techniques described herein relate to a method wherein the beverage flavoring pod is heat adhered to the beverage cup lid.

### BRIEF DESCRIPTION OF THE DRAWINGS

FIG. 1A is a perspective view of a beverage cup lid and the beverage cup.

FIG. 1B is a cross-section view of a beverage cup lid and the beverage cup, showing the flavoring material.

FIG. 2 is a diagram of a liquid dispensing device.

FIG. 3A is a drawing of a beverage material pod.

FIG. 3B is an exploded view of the beverage material pod.

FIG. 4 is a cross-section view of a beverage cup lid for an alternative embodiment.

FIG. 5 is a cross-section view of the beverage cup lid and the beverage cup with the liquid dispensing apparatus.

### DETAIL DESCRIPTIONS OF THE INVENTIONS

All illustrations of the drawings and the descriptions herein are for the purpose of describing selected versions of the present inventions and are not intended to limit the scope of the present inventions.

The descriptions herein use coffee as an example, but the devices and methods described could also apply to other beverages, hot, cold, and in-between. For example, beverage 501 could be coffee, tea, hot chocolate, soft drinks, alcoholic drinks, infused oils, vegetable juice, fruit juice, etc. The liquid 210 dispensed into the beverage flavoring material could be water, steam, carbonated water, alcohol (gin, rum, whiskey, vodka, wine, beer, mead, sake, brandy, vermouth, liquor, cognac, tequila, absinthe, Everclear, moonshine, etc.), milk (cow, goat, coconut, almond, etc), oil (olive oil, coconut oil, vegetable oil, etc). The beverage flavoring material 301 could be ground coffee bean, tea leaves, concentrated soft drink material, ground tree material (birch beer, root beer, sarsaparilla, etc.), leaves (basil, mint, oregano, chive, bay leaves, Cannabis, etc), vegetables (onions, peppers, tomato, beets, cabbage, melon, cucumber, squash, pumpkin, carrot, etc), fruit (apples, pears, peaches, pineapple, orange, grapefruit, banana, pomegranate, lemon, etc), berries (strawberry, raspberry, blackberry, grape, cranberry, etc.), nuts, etc.

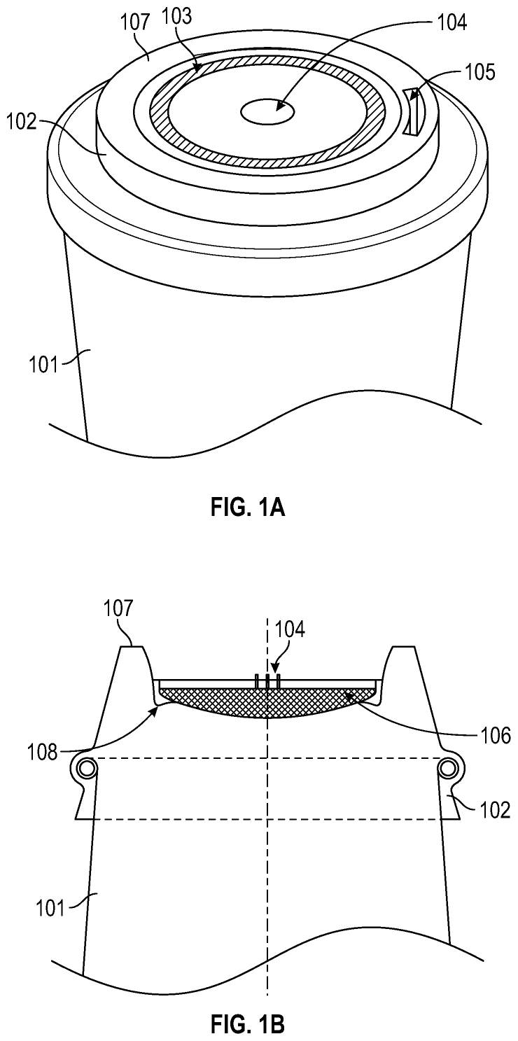

Looking to FIG. 1A, a beverage cup 101 is covered by a lid 102. The beverage cup 101 is used to hold the beverage 501 after brewing. The lid 102 may have a drinking hole 105 to allow a user to drink the beverage 501. The drinking hole 105 could be on a raised ridge 107 that circumvents the lid 102. There is also a filling or brewing hole 104 that is in the center of the lid 102 in some embodiments. In other embodiments, the brewing hole 104 could be elsewhere on the lid 102. In some embodiments, there are multiple brewing holes 104. The lid 102 may have a sealing surface 103. The sealing surface 103 may be a round flat area on the lid 102. The sealing surface 103 may create a circle just inside of the raised ridge 107 in some embodiments. In other embodiments, the sealing surface 103 may be a small circle that is slightly larger than the brewing hole 104.

The beverage cup 101 could be paper, cardboard, plastic (polyethylene, polypropylene, polystyrene, polyethylene terephthalate (PET), etc.), steel, stainless steel, glass, ceramic, aluminum, clay, pottery, porcelain, stoneware, Melamine, Styrofoam, silicon, bagasse, bamboo fiber, other plant fibers, etc. The lid 102 could be made of plastic (polyethylene, polypropylene, polystyrene, polyethylene terephthalate (PET), etc.), silicon, aluminum, cardboard, paper, steel, bagasse, bamboo fiber, other plant fibers, etc.

A cross-section of the lid 102 can be seen in FIG. 1B, showing one possible shape for the lid 102. Below the lid 102 is beverage flavoring pod 106. The beverage flavoring pod 106 could be held to the lid 102 with a hot crimped clip 108. One clip 108 could be on two sides of the lid 102, or any number of clips 108 could be used. Or heat-clamped clips 108 could be continuous around the edge of the beverage flavoring pod 106 holding the beverage flavoring pod 106 to the lid 102. In another embodiment, the beverage flavoring pod 106 could adhere to the lid 102 with an adhesive, such as PVC cement, hot glue, epoxies, resin, silicon sealants, etc. In still another embodiment, the beverage flavoring pod 106 could be heat adhered to the lid 102. In still another embodiment, a retaining ring could be used to hold the beverage flavoring pod 106 to the lid 102. The retaining ring could be a simple plastic, circle circumference-shaped ring. Or the retaining ring could be a circle area with one or more small drain holes. In another embodiment, the retaining ring could be one of a large number of patterns with various openings. The retaining ring could be plastic, foil, aluminum, or any other material.

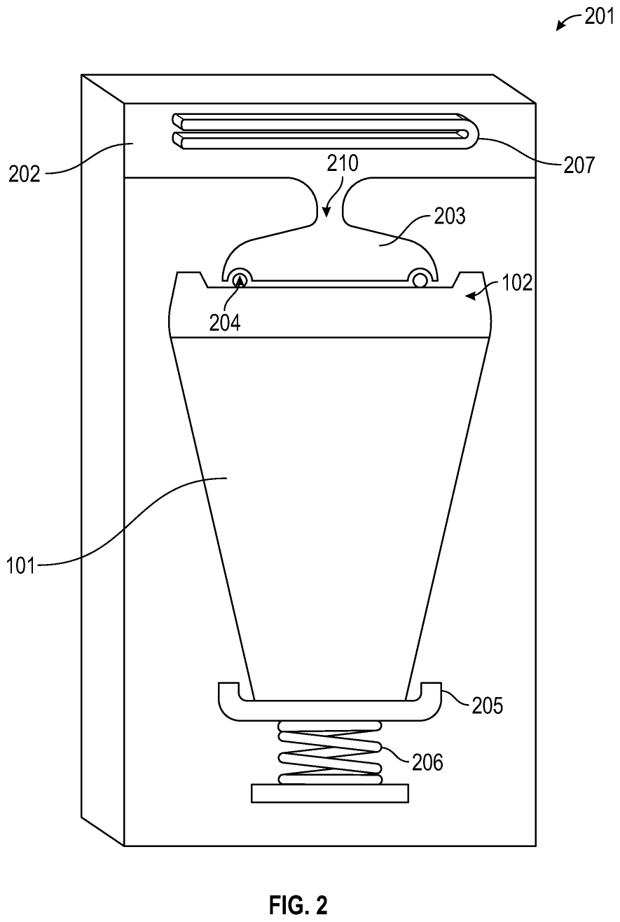

FIG. 2 shows the beverage cup 101 and lid 102 in a beverage brewing machine 201. The brewing machine 201 consists of a reservoir 202 of liquid 210, such as water. In some embodiments, the liquid 210 is heated as it moves into the dispensing dome 203. In other embodiments, the liquid 210 is heated in the reservoir 202. In some embodiments, the temperature is raised only a few degrees, and in other embodiments, the liquid 210 is converted into another form, such as steam. In some cases, superheated water is used. In some embodiments, the liquid 210 is cooled. In other embodiments, the temperature of the liquid 210 is not changed.

The dispensing dome 203 is sealed to the lid 102 with O-rings 204 to keep the liquid from spilling onto the lid 102 beyond the confines of the dispensing dome 203. The O-ring 204 is matched to the sealing surface 103, with the O-ring 204 sitting directly on the sealing surface 103. In some embodiments, the liquid 210 is under pressure in the dispensing dome 203. Pressure could be formed with a pump or through the conversion of the liquid into steam. Because the lid 102 has a brewing hole 104, the liquid 210 is forced into the lid 102, and into the beverage flavoring pod 106 holding the beverage flavoring material 301. In another embodiment, the liquid 210 is gravity fed into the brewing hole 104.

In some embodiments, the liquid is measured based on the amount of liquid leaving the reservoir 202, either by monitoring the liquid 210 level in the reservoir 202 or by measuring the amount of liquid 210 that flows through a tube. In still another embodiment, the liquid is measured by pumping the liquid 210 for a predetermined period of time.

In another embodiment, the beverage 501 is measured by monitoring the amount of force placed on the spring platform 205 by the beverage cup 101, as it compresses the spring 206.

A heating element 207 may reside in the reservoir 202 of the beverage brewing machine 201 to heat the liquid 210. In some embodiments, the heating element 207 heats the liquid 210 to steam. In other embodiments, the heating element 207 heats the liquid 210 to a super-heated state, perhaps to 450 degrees Fahrenheit, by maintaining pressure in the reservoir 202.

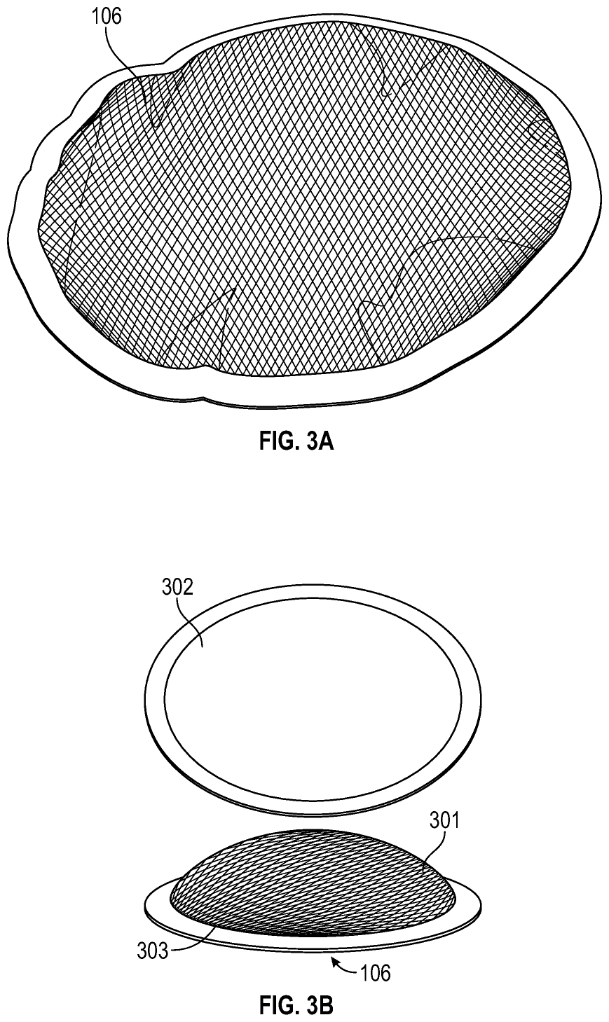

FIG. 3A shows the beverage flavoring pod 106 separate from the lid 102. The beverage flavoring pod 106 could be round in shape with fabric-like flexibility on shape, flexing when pushed.

FIG. 3B shows an exploded view of the beverage flavoring pod 106. One side is a first beverage filter 303, such as a round coffee filter, slightly larger than the size of the lid 102 inside of the raised ridge 107. The beverage flavoring material 301 is located on the first beverage filter 303. The quantity of the beverage flavoring material 301 will vary based on the characteristics of the beverage flavoring material 301. For instance, coffee may be mounded up on the coffee filter but a concentrated lemonade flavoring may cover the filter with a very fine layer. On top of the beverage flavoring material 301 is the second beverage filter 302. In some embodiments, the material of the second beverage filter 302 is different from the first beverage filter 303. The second beverage filter 302 could be for filtering the liquid 210. The first beverage filter 303 adheres to the second beverage filter 302 around the entire circumference. The first beverage filter 303 could adhere to the second beverage filter 302 with an adhesive, such as PVC cement, hot glue, epoxies, resin, silicon sealants, etc. In another embodiment, the first beverage filter 303 could be heat adhered to the second beverage filter 302. In another embodiment, the first beverage filter 303 could adhere with a crimped connection to the second beverage filter 302.

In another embodiment, the beverage flavoring pod 106 could only have the first beverage filter 303 and the beverage flavoring material 301. The beverage flavoring pod 106 could use the lid 102 to keep the beverage flavoring material 301 from spilling. In still another embodiment, the beverage flavoring material 301 could be infused into the beverage filter 303.

Beverage filter 303 could be made of polypropylene(PP), polyester(PE), stainless steel(SS), nylon, cotton, wool, carbon fiber, silicone, paper, plant fiber, cheesecloth, glass, cellulose, etc.

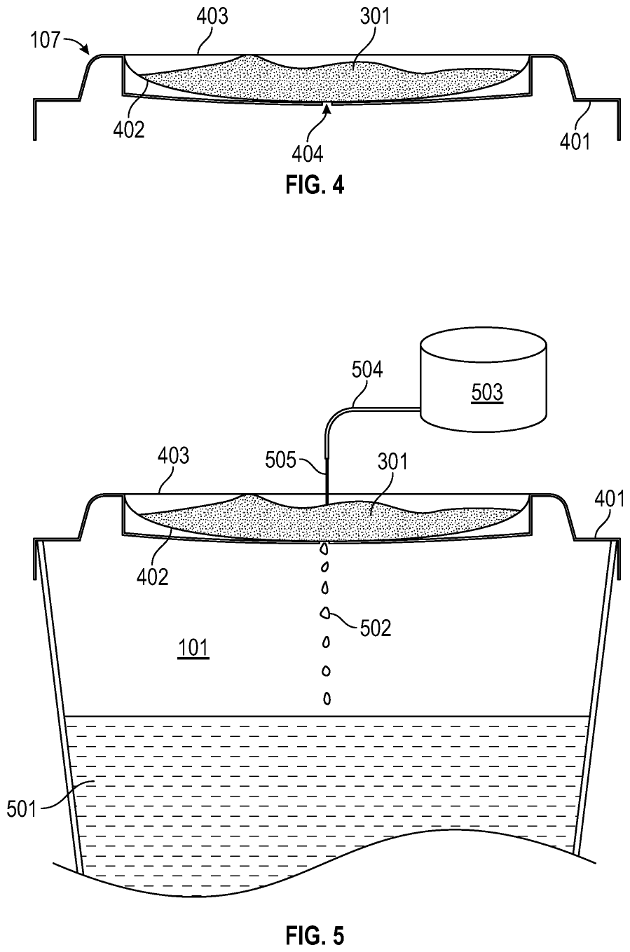

FIG. 4 shows a different embodiment. FIG. 4 shows a cross-section of a lid 401. This lid 401 is round with a raised ridge 107 and a drinking hole 105. The cross-section of the lid 401 shows a cylindrical shape between the raised ridges 107. The lid 401 in the area between the raised ridges 107 may have a slight slope to the center of the lid 401. The center of the lid 401 could have a hole 404 (or a plurality of holes 404) that allows the beverage 501 to drip into the beverage cup 101. The area between the raised ridges 107 could have a beverage filter 402. The beverage filter 402 could adhere to the top of the raised ridges 107. The beverage filter 402 could adhere to the top of the raised ridges 107 with an adhesive, such as PVC cement, hot glue, epoxies, resin, silicon sealants, etc. The beverage filter 402 could be heat adhered to the top of the raised ridges 107 The beverage filter 402 could mechanically adhere to the top of the raised ridges 107 with a retaining ring or crimping.

The beverage flavoring material 301 is placed on top of the beverage filter 402. A foil layer 403 extends from the raised ridges 107 over the beverage flavoring material 301 and the filter 402. The foil 403 could adhere to the top of the raised ridges 107. The foil 403 could adhere to the top of the raised ridges 107 with an adhesive, such as PVC cement, hot glue, epoxies, resin, silicon sealants, etc. The foil 403 could be heat adhered to the top of the raised ridges 107. The foil 403 could mechanically adhere to the top of the raised ridges 107 with a retaining ring or crimping. The foil 403 could adhere together with the beverage filter 402 to the raised ridges 107. In some embodiments, there is air between the beverage flavoring material 301 and the foil 403. In some embodiments, there is air between the lid 102 and the beverage filter 402. The foil 403 could be made of paper, foil, aluminum, cardboard, plastic (polyethylene, polypropylene, polystyrene, polyethylene terephthalate (PET), etc.), Styrofoam, silicon, bagasse, bamboo fiber, other plant fibers, etc.

FIG. 5 shows how liquid 210 is dispensed into the beverage flavoring material 301 to create the beverage 501. The liquid 210 is stored in a reservoir 503. The liquid 210 could be heated in the reservoir 503 ins some embodiments. In other embodiments, the liquid 210 is heated in the tubing 504. In some embodiments, the liquid 210 is cooled. In other embodiments, there is no adjustment in temperature. In some embodiments the reservoir 503 is pressurized. In other embodiments, the liquid is pressurized with a pump in the tubing 504. In some embodiments, the liquid 210 is not pressurized and flows through gravity.

Tubing 504 moves the liquid 210 from the reservoir 503 to a needle 505. The needle 505 has a sharp point that is used for piercing the foil 403 before dispensing liquid 210. The needle 505 is hollow and has one or more needle holes in the side, to allow liquid 210 to flow from the tube 504 into the beverage flavoring material 301. To make the beverage, when the cup and lid are placed in the beverage dispensing device, the beverage dispensing device pushes the needle 505 into the foil 403 and continues to extend far enough below the foil 403 to allow the needle holes on the side of the needle 505 to be placed above the beverage flavoring material 301 but below the foil 403. When the needle 505 is in place, the reservoir 503 releases the liquid 210 into the tube 504 and then to the needle 505.

In some embodiments, the needle 505 pierces both the foil 403 and the lid 401, creating the hole 404. The needle 505 is then retracted to allow the beverage 501 to flow through the hole 404.

When the needle 505 dispenses the liquid 210 into the beverage flavoring material 301, the cavity between the foil 403 and the beverage filter 402 fills with liquid 210. As the liquid 210 permeates the beverage flavoring material 301 and the beverage filter 402, the beverage is formed between the beverage filter 402 and the lid 401. The beverage 501 flows through the hole 404, forming a stream or drips 502 of beverage 501 as it follows into the beverage cup 101.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present inventions include such changes and modifications.

1. A apparatus comprising:
a beverage cup lid;
a beverage flavoring pod adhered to the beverage cup lid; and
the beverage flavoring pod comprising:
a first beverage filter;
beverage flavoring material on the first beverage filter; and
a second beverage filter covering the beverage flavoring material and adhered to the first beverage filter.

2. The apparatus of claim 1 wherein the beverage flavoring material is coffee.

3. The apparatus of claim 1 wherein the beverage flavoring material is tea.

4. The apparatus of claim 1 wherein the beverage flavoring pod is heat adhered to the beverage cup lid.

5. The apparatus of claim 1 the beverage flavoring pod adheres to the beverage cup lid with a hot crimped clip.

6. The apparatus of claim 1 the beverage flavoring pod is heat adhered to the beverage cup lid with an adhesive.

7. The apparatus of claim 1 wherein the beverage flavoring pod is mounted below the beverage cup lid.

8. The apparatus of claim 1 wherein the first beverage filter and the second beverage filter adhere to the beverage cup lid with a single adhesion mechanism.

9. The apparatus of claim 1 wherein the beverage cup lid has a sealing surface.

10. The apparatus of claim 1 wherein the beverage cup lid has a brewing hole.

11. A method for brewing a beverage comprising:
heating a liquid;
forcing the liquid through a beverage cup lid, where a beverage flavoring pod is attached to the beverage cup lid;
encasing the beverage flavoring pod with the liquid; and
the liquid flowing through the beverage flavoring pod into a beverage cup, the beverage cup mounted below the beverage cup lid.

12. The method of claim 11 wherein the liquid is forced through the beverage cup lid through gravity.

13. The method of claim 11 wherein the liquid is heated to steam.

14. The method of claim 12 wherein the beverage flavoring pod comprises:
a first beverage filter;
beverage flavoring material on the first beverage filter; and
a second beverage filter covering the beverage flavoring material and adhered to the first beverage filter.

15. The method of claim 14 wherein the beverage flavoring material is coffee.

16. The method of claim 14 wherein the beverage flavoring material is tea.

17. The method of claim 11 wherein the liquid is water.

18. The method of claim 11 wherein the liquid is heated to a super-heated state before it is forced into the beverage cup lid.

19. The method of claim 11 wherein the beverage flavoring pod is attached below the beverage cup lid.

20. The method of claim 11 wherein the beverage flavoring pod is heat adhered to the beverage cup lid.
